(19) United States
(12) Patent Application Publication
(10) Pub. No.: US 2003/0001748 A1
(43) Pub. Date: Jan. 2, 2003

(54) Apparatus and method of determining position by means of a flexible resistive circuit

(76) Inventor: Bruce T. Dalton, Cornish, ME (US)

Correspondence Address: C. John Brannon, Woodard, Emhardt, Naughton, Moriarty and McNett, Bank One Center/Tower, 111 Monument Circle, Suite 3700, Indianapolis, IN, 46204-5137, US

(21) Appl. No.: 09/993,197

(22) Filed: Nov. 19, 2001

Related U.S. Application Data
(60) Provisional application No. 60/287,459, filed on Apr. 30, 2001.

(51) Int. Cl. G08B 21/00

(52) U.S. Cl. 340/657

(57) ABSTRACT

A method of determining the location of a movable seat in a vehicle relative a stationary reference point therein. The method includes the steps of providing a flexible member characterized by electrical resistance as a function of curvature, operationally connecting the flexible member to the seat such that movement of the seat relative the reference point bends the flexible member, moving the seat relative the reference point, measuring the electrical resistance of the flexible member, and determining the location of the seat.

### CROSS-REFERENCE TO RELATED APPLICATIONS

This application claims priority to U.S. Provisional Application Serial No. 60/287,459 filed Apr. 30, 2001.

### TECNNICAL FIELD OF THE INVENTION

The invention relates generally to the field of automotive technology and, more particularly, to an apparatus and method for determining position by means of a flexible resistive circuit.

### BACKGROUND OF THE INVENTION

There is a need for detecting the forward/rearward position of a seat in an automobile, so that the seat may be adjusted to accommodate the size of a seated driver relative to the automobile controls and also so that the automobile airbag system can be managed for the size and proximity of an individual sitting in the seat. Deployment of the airbag system can be injurious or even fatal to vehicle occupants positioned too close to the deploying airbag. This is especially true if the passengers are frail, as is common with infants, children, the elderly, and the ill.

One important criterion of a seat position sensor is that these sensors are required to function equally well if the seat is repositioned hundreds or thousands of times or if years or decades pass between seat repositionings. In other words, the detector must not substantially degrade from either repeated usage or from prolonged disuse.

Current technologies useful for tracking seat position include magnetic, inductive, ultrasonic, seatbelt spool-out, potentiometer sliding brush, mechanical, microwave and optical devices. While all of these technologies are useful, each suffers from some flaws. For example, optical sensing devices usually include an emitter and a detector positioned with a portion of the movable, perforated seat rail therebetween. The optical sensor system is especially susceptible to interference from dust, dirt, and assorted detritus generated during the operation of the automobile that may partially or completely obstruct the optical path between the emitter and the detector, thereby disabling the optical detector system. This becomes an especially troublesome problem if the sensor is left in disuse for long periods of time, as the optical pathway may become gradually obstructed. The optical system is also subject to errors arising from a misalignment of the emitter and the detector.

Sonic echo sensors having an active sound emitter and a sound detector may be used to interrogate the position of the seat. The active emitter is positioned to direct a sound beam toward the seat. By detecting the echo, the position of the seat relative the emitter and/or detector may be calculated. This system may also determine the proximity of passengers within the seat to the air bags by direct interrogation. However, this system is susceptible to interference form sound-emitting devices (especially in the ultrasonic range) and cannot distinguish between passengers and inanimate objects on the seat. This system also directs an ultrasound beam at the passengers, which may interfere with such things as hearing aids, and may be blocked and/or deflected. Moreover, this system is bulky and, due to it's placement within the vehicle, is also readily susceptible to misalignment of the emitter, the detector, or both.

Sensors utilizing a magnetic element, such as a Hall effect sensor, require the placement of a magnetic strip on or adjacent the seat rail. The placement and length of the strip defines the detectable switchpoints for detection by a magnetic sensor. While not as susceptible to interference from dirt, dust, moisture or the like, the magnetic sensor is susceptible to electromagnetic interference from such items as speakers, metallic objects, and other magnets. The system is also susceptible to damage from repeated use, since repetitive motion of the seat may cause dislodging or misalignment of the sensor and/or magnetic strip.

An inductive sensor system utilizes an active sensor to detect the presence of metallic objects. The movable seat rail may have a profile cut thereinto, and a stationary sensor can be used to read the profile to determine the position of the rail relative the sensor. However, this system is especially susceptible to interference from foreign metallic objects.

There is therefore a need for a seat position sensor system that is reliable, is resistant to dust, dirt, interference from metallic and/or magnetic objects, and is positioned away from sources of accidental misalignment and the like. The present invention addresses this need.

### SUMMARY OF THE INVENTION

The present invention relates to a vehicular seat position detector. The position detector includes a rail having a profile, a seat movable relative to the rail, an elongated member having a first end pivotably connected to the seat and a second end extending to the rail, and a flexible member having electrical resistance and connected between the elongated member and the rail. Moving the seat relative the rail actuates the second end to trace the profile, thereby pivoting the elongated member. Pivoting of the elongated member actuates flexure of the flexible member, wherein the electrical resistance of the flexible member is a known function of the flexure of the flexible member. Flexure of the flexible member changes the electrical resistance of the flexible member, allowing the position of the seat to be calculated by measuring the electrical resistance of the flexible member.

One object of the present invention is to provide an improved seat position detector for an automobile. Related objects and advantages of the present invention will be apparent from the following description.

### BRIEF DESCRIPTION OF THE DRAWINGS

FIG. 1 is a partial schematic diagram of a first embodiment of a position detector having a flexible member of variable resistance attached thereto.

FIG. 2A is a partial schematic diagram of the position detector of FIG. 1 wherein the rail includes a plurality of steps.

FIG. 2B is a partial schematic diagram of the position detector of FIG. 1 wherein the rail is substantially smoothly sloped.

FIG. 3A is a first partial schematic diagram of a second embodiment of a position detector having a flexible member of variable resistance connected between a stationary member and a pivotable armature attached thereto.

FIG. 3B is a second partial schematic diagram of the embodiment of FIG. 3A.

FIG. 4A is a schematic diagram of a third embodiment of a position detector having a flexible member of variable resistance connected between a pivotable member and a stationary reference member.

FIG. 4B is a schematic diagram of the embodiment of FIG. 4A wherein the pivotable member is further pivoted in a first direction.

FIG. 4C is a schematic diagram of the embodiment of FIG. 4A wherein the pivotable member is further pivoted in a second direction.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

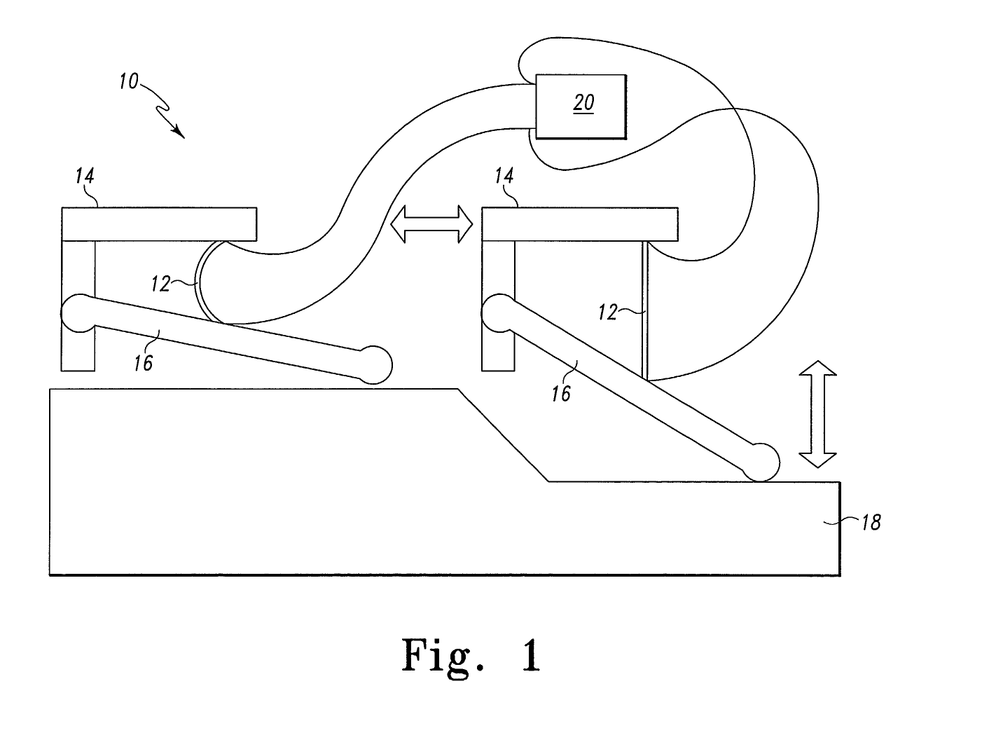

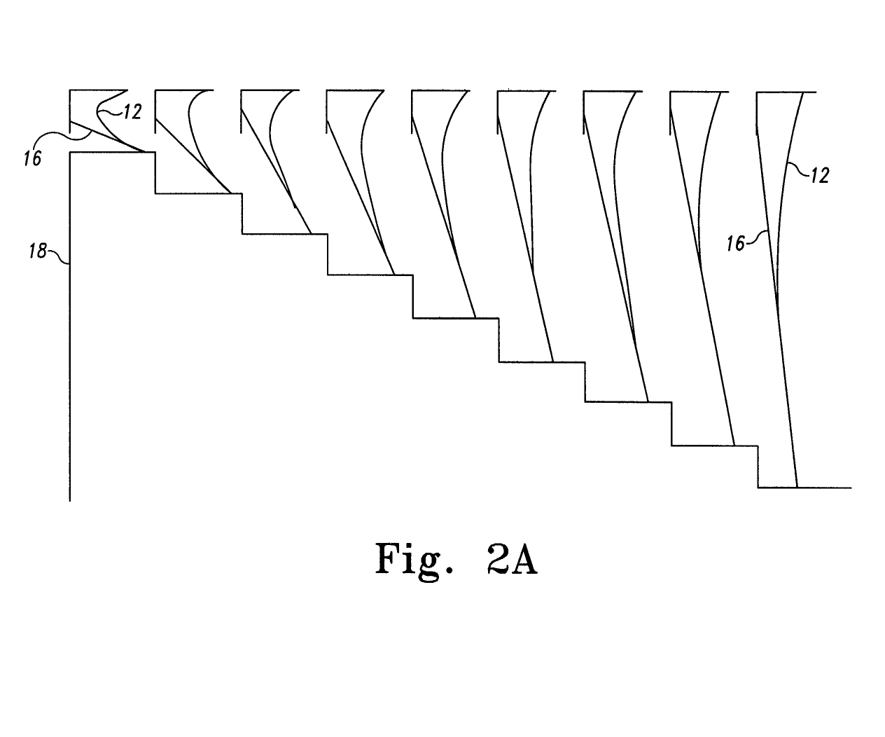

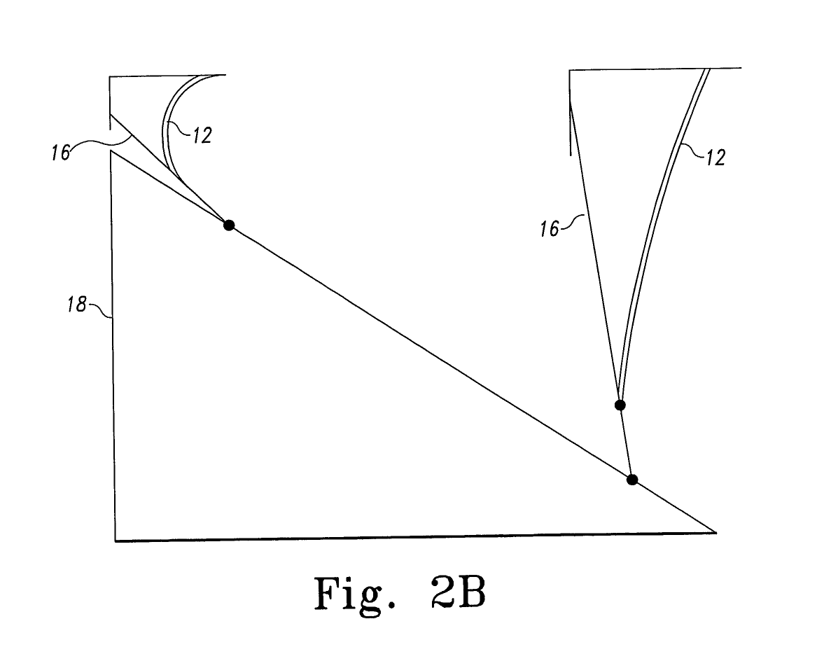

FIGS. 1, 2A and 2B illustrate a first embodiment of the present invention, a position detector 10 for measuring the position of a movable component in a vehicle such as an automobile, truck, airplane or the like. The position detector 10 includes a flexible strip or member 12 having an electrical resistance that predictably varies as a function of its flexure or curvature. In other words, as the flexible member 12 is bent, its resistance changes according to known parameters. Examples of such flexible members characterized by electrical resistance as a function of flexure and their manufacture are discussed in U.S. Pat. Nos. 5,086,785 to Gentile et al.; 5,157,372 to Langford; and 5,583,476 to Langford, each incorporated by reference herein in its entirety.

The exterior of the flexible member 12 is preferably substantially electrically and chemically insulated. The flexible member 12 is connected at one end to a movable vehicular component 14, such as a seat. The flexible member 12 is connected such that movement of the seat 14 causes the curvature or flexure, and thereby the electrical resistance, of the flexible member 12 to change. The component 14 may move linearly, such as by sliding from front to back, from side to side or up and down, or may move pivotally.

In this embodiment, the vehicular component 14 may be taken as a car seat that is adapted to slide from front to back. The seat 14 includes an armature member 16 pivotably connected thereto. The seat 14 may be movable relative to a stationary profiled rail 18 connected to the vehicle. The armature 16 extends from the seat 14 to contact the rail 18. As the seat 14 moves relative the rail 18, the end of the armature 16 in contact with the rail 18 traces or follows the profile. The rail 18 is preferably profiled such that as the seat 14 moves, the distance between the seat 14 and the rail 18 changes, either discontinuously (i.e., the profile-is stepped, as shown in detail in FIG. 2A) or smoothly (i.e., the profile is inclined, as shown in more detail in FIG. 2B). The flexible member 12 is preferably connected between the pivotable armature 16 and the seat 14, such that as the seat 14 moves relative the rail 18, the armature 16 pivots to follow the rail profile and the flexure of the flexible member 12 changes accordingly. The electrical resistance of the flexible member 12 may be measured, such as by an ohmmeter or electronic controller 20 connected thereto. The position of the seat 14 may be calculated by using a known relationship between the resistance of the flexible member 12 and its curvature to determine the curvature, and then by using a known relationship between the curvature of the flexible member 12 and the position of the seat 14 to determine the position of the seat 14.

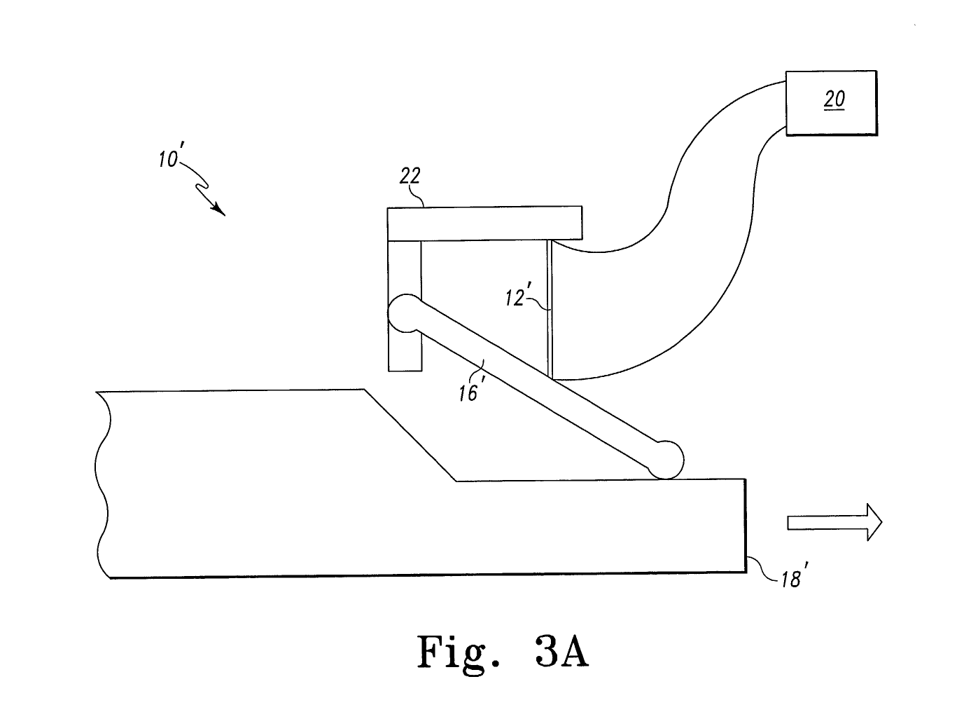

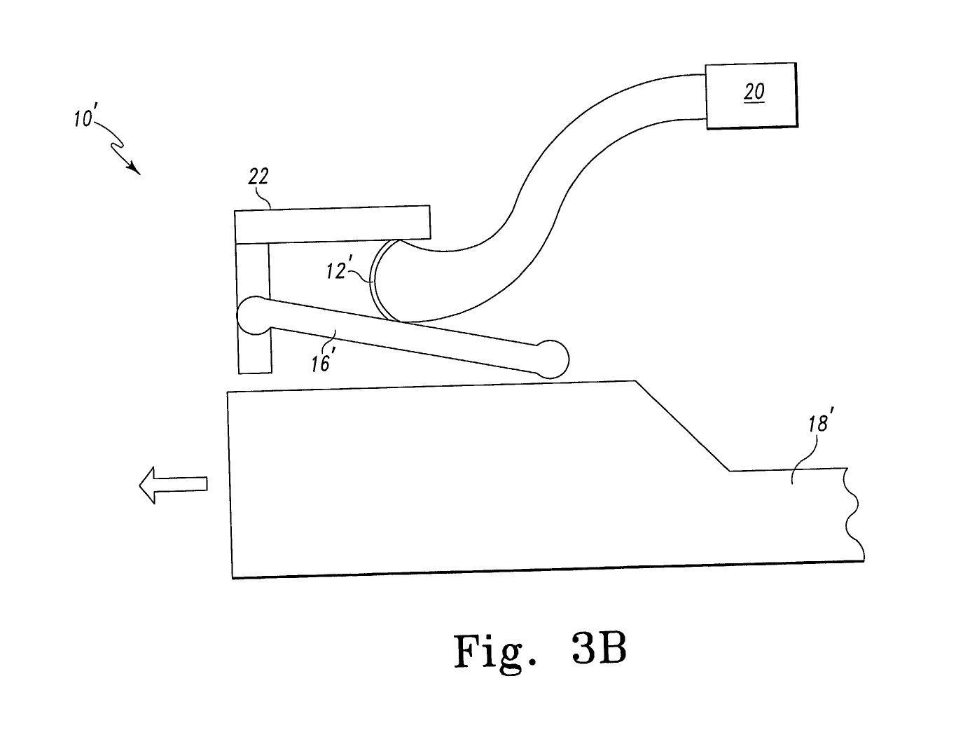

A second embodiment of the present invention is disclosed in FIGS. 3A and 3B. In this embodiment, the vehicular position detector 10′ includes a flexible strip 12′ connected between a stationary reference point or member 22 and a pivotable armature or member 16′. The flexible strip 12′ is again characterized as having an electrical resistance that predictably varies as a function of its flexure or curvature. The position detector 10′ also includes a movable profiled rail portion 18′. The profiled rail portion 18′ is connected to a movable member or component 14′, taken hereinafter as a slideable car seat. As the seat 14′ moves, so does the rail 18′. As above, the pivotable member 16′ is connected with one end in contact with and following the profile of the rail 18′. The end of the pivotable member 16′ therefore traces the profile of the rail 18′ as the seat 14′ and the connected rail 18′ move. The flexible member 12 is preferably connected between the pivotable armature 16′ and the reference point 22 such that as the seat 14′ and rail 18′ move past the reference point 22, the armature 16′ pivots to follow the rail profile and the flexure of the flexible member 12′ changes accordingly. The electrical resistance of the flexible member 12′ may be measured, such as by an ohmmeter or electronic controller 20 connected thereto. The position of the seat 14′ may be calculated by using a known relationship between the resistance of the flexible member 12′ and its curvature to determine the curvature, and then by using a known relationship between the curvature of the flexible member 12′ and the position of the seat 14′ to determine the position of the seat 14′.

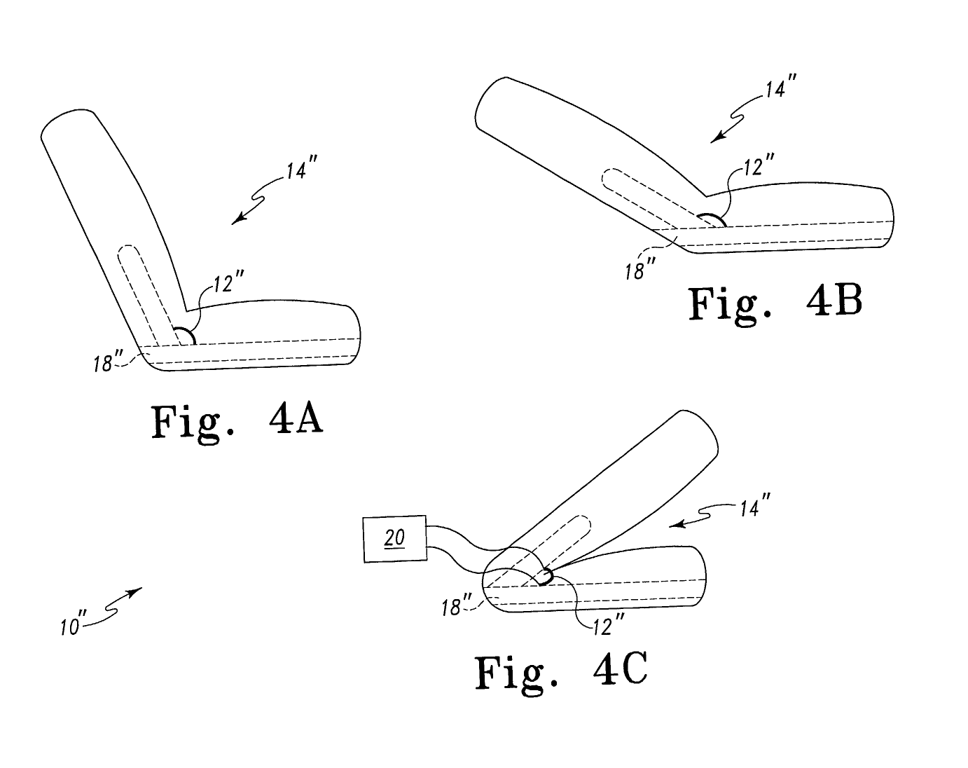

A third embodiment of the present invention is illustrated in FIGS. 4A-4C, and includes a movable vehicular component 14″, wherein at least a portion thereof is adapted pivot or rotate through an arc. As in the previous embodiments, the movable vehicular component may be a seat 14″. The seat 14″ is at least partially pivotable relative to the vehicle. A flexible member 12″ characterized by variable electrical resistance as a function of bend or curvature is connected between the seat 14″ and a stationary member 18″ connected to the vehicle. The relationship between the curvature and the electrical resistance of the flexible member 12″ is preferably stable and more preferably well known. The flexible member 12″ is connected such that pivoting the seat 14″ through a predetermined arc amount changes the curvature of the flexible member 12″ by a predetermined amount, thereby changing its electrical resistance. Since the relationships between the arc traversed by the pivoting seat 14″ and the curvature of the flexible member 12″ and between the curvature of the flexible member 12″ and its electrical resistance are known, it is possible to determine the position of the pivoted seat 14″ by measuring the electrical resistance of the flexible member 12″. This may be accomplished by connecting an ohmmeter or electronic controller 20 in electric communication with the flexible member 12″.

While the above embodiments contemplate the vehicular component as being a seat 14, the present invention may be practiced with any moving vehicular component, such as a window, a steering column, the windshield wipers, or the like.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A vehicular seat position detector, comprising:
a rail having a profile;
a seat movable relative to the rail;
an elongated member having a first end pivotably connected to the seat and a second end extending to the rail; and
a flexible member having electrical resistance and connected between the elongated member and the rail;
wherein moving the seat relative the rail actuates the second end to trace the profile, thereby pivoting the elongated member;
wherein pivoting of the elongated member actuates flexure of the flexible member; and
wherein the electrical resistance of the flexible member is a function of the flexure of the flexible member.

2. The detector of claim 1 further comprising an electronic controller operationally connected to the flexible member, wherein the electronic controller is adapted to measure the electrical resistance of the flexible member and wherein the electronic controller is adapted to calculate the position of the seat.

3. The detector of claim 1 wherein the flexible member is substantially electrically and chemically insulated.

4. The detector of claim 1 wherein the profile is stepped away from the seat.

5. The detector of claim 1 wherein the seat moves linearly and wherein the rail is oriented parallel to the motion of the seat.

6. The detector of claim 1 wherein the seat pivots.

7. An automotive position indicator, comprising:
a positionable member;
a stationary member; and
a flexible member having electrical resistance operationally connected to between the positionable member and the stationary member;
wherein the electrical resistance of the flexible member is a function of the flexure of the flexible member;
wherein there is a predetermined relationship between the electrical resistance of the flexible member and the position of the positionable member.

8. The position indicator of claim 7 further comprising a microprocessor in electric communication with the flexible member, wherein the microprocessor is adapted to measure the electrical resistance of the flexible member and wherein the microprocessor is adapted to determine the position of the positionable member.

9. The position indicator of claim 7 wherein the positionable member is a seat.

10. The position indicator of claim 9 wherein the stationary member is a rail and wherein the seat is adapted to linearly slide relative to the rail.

11. The position indicator of claim 9 wherein the seat is adapted to pivot.

12. A method of determining the position of a positionable seat in an automobile relative a stationary reference point, comprising the steps of:
a) providing a flexible member having an electrical resistance as a function of flexure;
b) predetermining a relationship between the electrical resistance of the flexible member and the position of the seat;
c) connecting the flexible member between the seat and the stationary reference point;
d) measuring the resistance of the flexible member;
e) calculating the position of the seat.

13. The method of claim 12 wherein the seat is adapted to pivot and wherein pivoting the seat flexes the flexible member.

14. The method of claim 12 wherein the seat is adapted to slide and wherein sliding the seat flexes the flexible member.

15. A method of determining the location of an movable seat in a vehicle relative a stationary reference point therein, comprising the steps of:
a) providing a flexible member characterized by electrical resistance as a function of curvature;
b) operationally connecting the flexible member to the seat such that movement of the seat relative the reference point flexes the flexible member;
c) moving the seat relative the reference point;
d) measuring the electrical resistance of the flexible member; and
e) determining the location of the seat.

16. The method of claim 15 wherein the stationary reference point comprises a rail profiled relative to the seat, wherein the seat includes a pivotable armature extending to the rail, wherein the pivotable armature follows the profile of the rail, and wherein the flexible member extends from the seat to the pivotable armature.

17. The method of claim 15 wherein the seat is adapted to pivot.
